(19) United States
(12) Patent Application Publication
(10) Pub. No.: US 2024/0164970 A1
(43) Pub. Date: May 23, 2024

(54) SURGICAL LEG HOLDER

(71) Applicant: New York Society for the Relief of the Ruptured and Crippled, maintaining the Hospital for Special S, New York, NY (US)

(72) Inventors: Thomas Zamorski, New York, NY (US); Mikhail Bachayev, New York, NY (US)

(73) Assignee: New York Society for the Relief of the Ruptured and Crippled, maintaining the Hospital for Special S, New York, NY (US)

(21) Appl. No.: 18/517,886

(22) Filed: Nov. 22, 2023

Related U.S. Application Data
(60) Provisional application No. 63/427,709, filed on Nov. 23, 2022.

(51) Int. Cl. A61G 13/12

(52) U.S. Cl. CPC A61G 13/1245; A61G 13/126; A61G 13/1295

(57) ABSTRACT

A surgical leg holder for manipulating a leg during surgery that includes a frame comprising a proximal femoral portion, a joint and a tibial portion distal the joint, the frame capable of angular adjustment about the joint. The surgical leg holder also includes one or more handles extending from the frame; and one or more fasteners to circumscribe at least a portion of a leg to secure the leg to the frame.

### CROSS REFERENCE TO RELATED APPLICATIONS

The present application claims the benefit of U.S. Provisional Application No. 63/427,709, filed Nov. 23, 2022, and is hereby incorporated by reference in its entirety.

### BACKGROUND OF THE DISCLOSURE

The exemplary embodiments of present invention relate generally to a surgical leg holder that can be used to manipulate a leg during surgery.

Various surgical techniques require that medical professionals support and manipulate one or more legs of a patient over extended time periods. For example, hip replacement surgery may require that medical professionals exert the effort to dislocate, rotate, or manipulate the hip joint for proper surgical exposure and component placement.

The burden placed on medical professionals to hold the leg under these circumstances can result in fatigue and cramping. As a result, the physical support provided by the medical professional can diminish, leading to inadequate surgical exposure, improper bone preparation, and poor intra-operative limb positioning. These issues may then negatively impact surgical outcomes including, e.g., fractures of the femur and less than optimal positioning of implant components.

One solution currently on the market is a surgical table designed specifically for surgical procedures that require that the leg be supported. The Hana® is a surgical table designed to provide linear distraction to the patient's leg in order to sufficiently open and expose the hip joint for surgical treatment, providing constant mechanical traction. Unfortunately, the Hana® is expensive, consumes valuable operating room space, and is known to cause patients post-operative peroneal nerve pain. As such, there remains a need for a more cost-effective solution to address the need of medical professionals to support and manipulate the leg of a patient during surgery that overcomes these disadvantages.

### SUMMARY OF THE DISCLOSURE

One embodiment of the disclosed subject matter provides a surgical leg holder for manipulating a leg during surgery that includes a frame comprising a proximal femoral portion, a joint and a tibial portion distal to the joint, the frame capable of angular adjustment about the joint; one or more handles extending from the frame; and one or more fasteners to circumscribe at least a portion of a leg to secure the leg to the frame.

In one exemplary embodiment, at least one handle extends from both the femoral portion and the tibial portion of the frame. In another exemplary embodiment, at least one handle is a single, u-shaped handle with one end extending from the femoral portion of the frame and one end extending from the tibial portion of the frame. In yet another exemplary embodiment, at least one handle comprises a first handle extending from the femoral portion of the frame and a second handle extending from the tibial portion of the frame.

In one exemplary embodiment, the surgical leg holder further includes one or more pads secured to, or otherwise in structural communication with an inner side of the frame. For example, the surgical leg holder can include at least one pad secured to the femoral portion of the frame and at least one pad secured to tibial portion of the frame.

In one exemplary embodiment, the femoral portion of the frame includes a femoral portion end connector and a thigh shaft, the femoral portion end connector capable of being placed in a first position in which the femoral portion end connector is movable about thigh shaft about an axial direction and a second position in which the femoral portion is locked with respect to the thigh shaft. In yet another embodiment, the tibial portion of the frame includes a tibial portion end connector movable about a tibial shaft, the tibial portion end connector capable of being placed in a first position in which the tibial portion end connector is movable about the tibial shaft about an axial direction and a second position in which the tibial portion is locked with respect to the tibial shaft. In yet another embodiment, a distal end of the femoral portion of the frame is defined by a hub and a proximal end of the tibial portion of the frame is defined by a second hub. For example, in an exemplary embodiment, the joint is capable of being placed in a first position in which the first hub is rotatable about the second hub and a second position in which the first hub and second hub cannot be rotated with respect to each other.

In one exemplary embodiment, the one or more fasteners includes one or more of a belt, strap, sleeve or clamp. In yet another exemplary embodiment, the surgical leg holder further includes a second frame, the one or more fasteners securing the leg between the first frame and the second frame. In a still further embodiment, a single handle extends from the first frame and the second frame. The outer surface of the frame can include, in exemplary embodiments, one or more handle mating members.

Another embodiment of the subject disclosure provides a method of manipulating a leg during a surgical procedure that includes introducing the leg to any of the surgical leg devices disclosed here and using the device to manipulate the leg during surgery.

### BRIEF DESCRIPTION OF THE DRAWINGS

The foregoing summary, as well as the following detailed description of the exemplary embodiments of the subject disclosure, will be better understood when read in conjunction with the appended drawings. For the purpose of illustrating the present disclosure, there are shown in the drawings exemplary embodiments. It should be understood, however, that the subject application is not limited to the precise arrangements and instrumentalities shown.

FIG. 1 depicts a perspective view of a surgical leg holder according to an exemplary embodiment of the subject disclosure;

FIG. 2 depicts a perspective view of the surgical leg holder of FIG. 1 in a second position;

FIG. 3 depicts the frame of the surgical leg holder of FIG. 1;

FIGS. 3A and 3B depict perspective views of frame components of the surgical leg holder of FIG. 1.

FIG. 4 depicts the joint of the surgical leg holder of FIG. 1;

FIG. 5 is a cross-sectional view of the joint of FIG. 4;

FIG. 6A is an exploded view of a joint according to an alternative embodiment;

FIGS. 6B and 6C depict components employed in the joint disclosed in FIG. 6A.

FIGS. 7A, 7B, and 7C depict cam levers of the surgical leg holder of FIG. 1;

FIGS. 8A, 8B, 8C and 8D depict components of the handle and their attachment to the surgical leg holder of FIG. 1;

FIGS. 9A, 9B and 9C disclose a handle according to an alternative embodiment;

FIGS. 10A, 10B, 10C, and 11 disclose components from a handle according to yet another embodiment, and their attachment to the surgical leg holder of FIG. 1;

FIG. 12 depicts a perspective view of a surgical leg holder according to another exemplary embodiment of the subject disclosure;

FIGS. 13 and 14 depict perspective views of a surgical leg holder according to yet another exemplary embodiment of the subject disclosure;

FIGS. 15A and 15B depict the frame of the surgical leg holder of FIGS. 13 and 14;

FIGS. 16A and 16B depict the joint of the surgical leg holder of FIGS. 13 and

FIG. 17 depicts components of the handle of the surgical leg holder of FIGS. 13 and 14;

FIGS. 18 and 19 depict a perspective view of a surgical leg holder according to a still further exemplary embodiment of the subject disclosure;

FIG. 20 depicts the frame of the surgical leg holder of FIGS. 18 and 19;

FIGS. 21 and 22 depict the joint of the surgical leg holder of FIGS. 18 and 19;

FIG. 23 depicts an end of the surgical leg holder of FIGS. 18 and 19;

FIG. 24 depicts a perspective view of a surgical leg holder according to another exemplary embodiment;

FIG. 25 depicts a perspective view of a surgical leg holder according to another exemplary embodiment;

FIG. 26 depicts a perspective view of a surgical leg holder according to another exemplary embodiment;

FIG. 27 depicts a perspective view of a surgical leg holder according to another exemplary embodiment;

FIGS. 28A, 28B, and 28C depict a surgical leg holder according to another exemplary embodiment;

FIGS. 29A, 29B, and 29C depict a surgical leg holder according to another exemplary embodiment;

### DETAILED DESCRIPTION OF THE DISCLOSURE

Reference will now be made in detail to the various exemplary embodiments of the subject disclosure illustrated in the accompanying drawings. Wherever possible, the same or like reference numbers will be used throughout the drawings to refer to the same or like features. It should be noted that the drawings are in simplified form and are not drawn to precise scale. Certain terminology is used in the following description for convenience only and is not limiting. Directional terms such as top, bottom, left, right, above, below and diagonal are used with respect to the accompanying drawings. The term “distal” shall mean away from the center of a body. The term “proximal” shall mean closer towards the center of a body and/or away from the “distal” end. The words “inwardly” and “outwardly” refer to directions toward and away from, respectively, the geometric center of the identified element and designated parts thereof. Such directional terms used in conjunction with the following description of the drawings should not be construed to limit the scope of the subject application in any manner not explicitly set forth. Additionally, the term “a,” as used in the specification, means “at least one.” The terminology includes the words above specifically mentioned, derivatives thereof, and words of similar import.

“About” as used herein when referring to a measurable value such as an amount, a temporal duration, and the like, is meant to encompass variations of ±20%, ±10%, ±5%, ±1%, or ±0.1% from the specified value, as such variations are appropriate.

“Substantially” as used herein shall mean considerable in extent, largely but not wholly that which is specified, or an appropriate variation therefrom as is acceptable within the field of art.

Throughout the subject application, various aspects thereof can be presented in a range format. It should be understood that the description in range format is merely for convenience and brevity and should not be construed as an inflexible limitation on the scope of the subject disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages and characteristics of the exemplary embodiments of the subject disclosure may be combined in any suitable manner in one or more embodiments. One skilled in the relevant art will recognize, in light of the description herein, that the subject disclosure can be practiced without one or more of the specific features or advantages of a particular exemplary embodiment. In other instances, additional features and advantages may be recognized in certain embodiments that may not be present in all exemplary embodiments of the present disclosure.

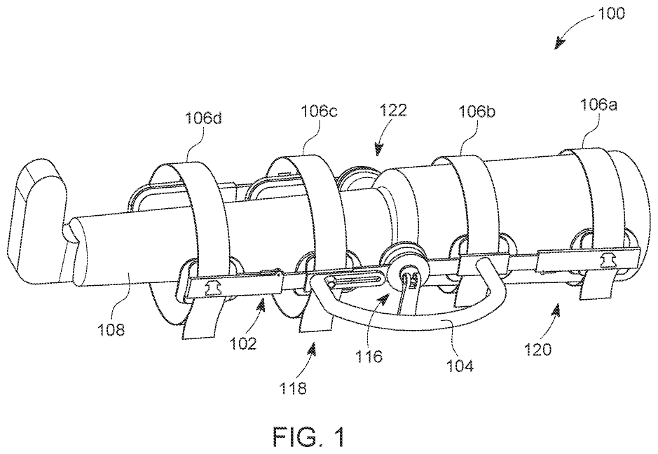

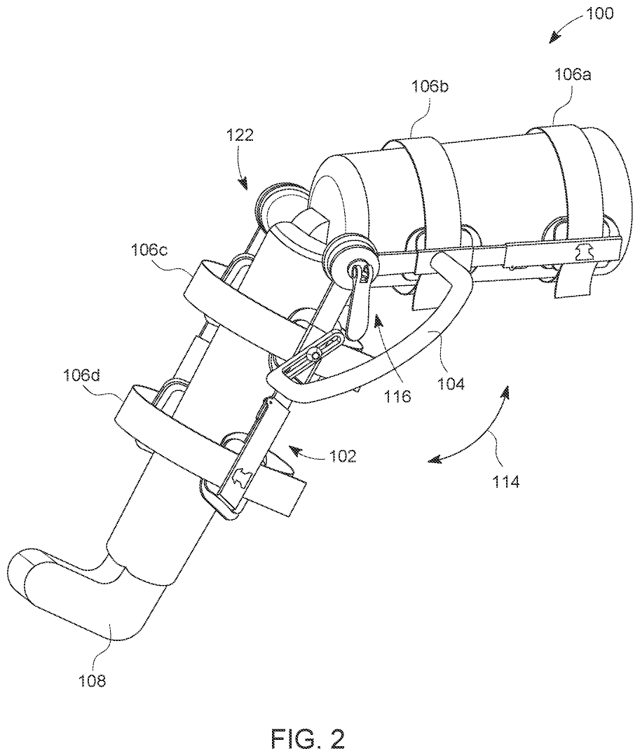

Referring now to the drawings, FIGS. 1 and 2 illustrate a surgical leg holder 100 according to an exemplary embodiment of the subject disclosure. The surgical leg holder includes a frame 102 that can be angularly adjusted, a handle 104 extending from the frame, and four fasteners 106a-106d in the exemplary form of four straps to circumscribe a portion of a leg 108. While additional details regarding the frame 102, handle 104 and fastener (strap) 106 are described below, it is understood that all of the other frames, handles, or fasteners disclosed herein are generally interchangeable, and can be applied to surgical leg holder 100, or any of the other exemplary leg holders disclosed herein, though not mentioned specifically in connection therewith.

As noted, in this exemplary embodiment the fastener is in the form of four straps 106a-106d. In this exemplary embodiment, the straps are flexible and provided with hook and loop type fasteners (e.g., Velcro®), although less-flexible straps (e.g., straps similar to snowboard-binding type straps or thin wires in connection with a Boa® fit system and the like) can be employed. Alternatively, any other strap or similar mechanism disclosed herein or known to those of ordinary skill can be used to secure the leg to or within the frame(s).

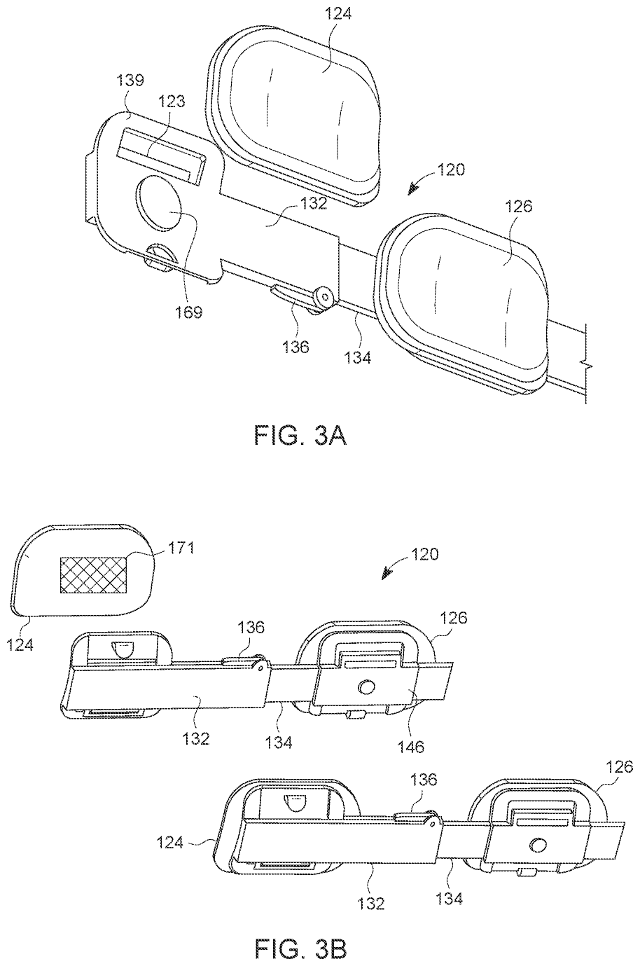

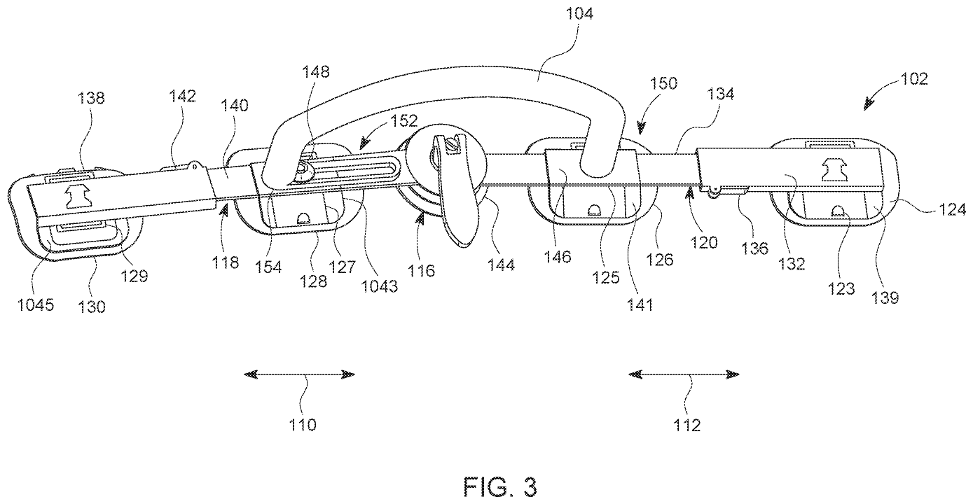

FIG. 3 depicts the frame 102 and handle 104 extending from the frame. The frame 102 is capable of being moved in an axial direction, independently, along a length 110 of a lower portion of the device and adjacent the tibia and along a length 112 of an upper portion of the device and adjacent the femur, when used by a subject. The frame is also capable of angular adjustment 114 (e.g., between the position shown in FIG. 1 and the position shown in FIG. 2) about a joint 116 located between a tibial portion 118 and a femoral portion 120 of the frame 102, the joint 116 spaced on the device to be in a position generally adjacent to the knee of a subject for which the device is being utilized.

In this exemplary embodiment, the femoral portion 120 of the frame 102 includes an upper thigh pad 124 mounted on the frame via a relatively rigid support 139, to define a proximal end of the femoral portion, and a lower thigh pad 126 of similar or like construction and size located proximal to the joint 116 mounted on a thigh shaft 134 of the frame via a second relatively rigid support 141. The thigh pads 124, 126 (and the calf pads 128, 130) are composed of foam in this exemplary embodiment, though an equivalent material of varying softness and flexibility can be used in the alternative.

The thigh pads 124, 126 and relatively rigid supports, 139, 141 are provided about the femoral portion 120 of the frame in this exemplary embodiment as shown best in FIGS. 3A and 3B. A femoral portion end connector 132, discussed below, is formed integral with the relatively rigid support 139, though the two components can be provided as separate components and secured to each other by standard means. The thigh shaft 134 is provided with a housing 146 adjacent the upper thigh pad 126. The housing 146 in this exemplary embodiment is formed integral with the relatively rigid support 141, and secured to the frame by a press or interference fit, fasteners, or any standard means. Again, the relatively rigid support 141 and housing 146 can alternatively be provided as separate components.

With continued reference to FIGS. 3A and 3B, a pad 169 is centrally provided on the relatively rigid support 139, facing the back side of the upper thigh pad 124. The pad 169 is provided with hook-and-loop type (e.g., Velcro®) fasteners, though like and functionally equivalent mechanisms can also be employed. A complimentary pad 171, provided with mating hook-and-loop type fasteners, is provided on back side of the upper thigh pad 124, and positioned to engage the pad 169 to secure the upper thigh pad to the relatively rigid support 139. The lower thigh pad 126 is secured to the relatively rigid support 141 in a like manner.

A slot or recess 123 is defined on the relatively rigid backing 139, and a slot or recess 125 is similarly defined on the rigid backing 141, each slot or recess sized to receive the straps 106a and 106b, respectively, to secure the fasteners to the femoral portion 120 of the frame 102.

The tibial portion 118 includes an upper calf pad 128 and a lower calf pad 130 of similar or like constructions and size mounted thereon, the lower calf pad defining the distal end of the frame. As with the thigh pads, the calf pads 128, 130 are mounted to the frame via relatively rigid backings 1043, 1045 which in turn can be mounted to the frame, frame housing or tibial end connector piece or formed integral therewith as described above in connection with the femoral portion 120. A recess 127 is defined on the rigid backing 1043 and upper calf pad 128 and a recess 129 is defined on the rigid backing 1045 and lower calf pad 130, each recess sized to receive the straps 106c and 106d, respectively to secure the fasteners to the tibial portion 118 of the frame.

A joint pad 144 is provided adjacent the joint 116, and is provided on the inner portion of the device, in like manner as pads 124, 126, 128, 130. The pads can be comprised of foam or other like material to provide a soft and/or supporting surface for the leg, and, as alternatives to the methods described above, can be mounted on the frame by way of a fastener, press fit, housing or other technique known to the skilled artisan.

As noted above, the femoral portion of the frame 102 is composed of the femoral portion end connector 132 and the thigh shaft 134. In this exemplary embodiment, the femoral portion end connector is a female member which is dimensioned to receive a proximal end of the thigh shaft 134. The position of the femoral portion end connector about the thigh shaft 134 can be adjusted by way of a femoral cam lever 136, though other mechanisms known to the skilled artisan can be employed in its place. In this exemplary embodiment the femoral portion end connector 132 is composed of plastic, and includes the relatively rigid backing 139 formed integrally therewith. The thigh shaft is composed of a metal (e.g., stainless steel), though other materials can be provided instead.

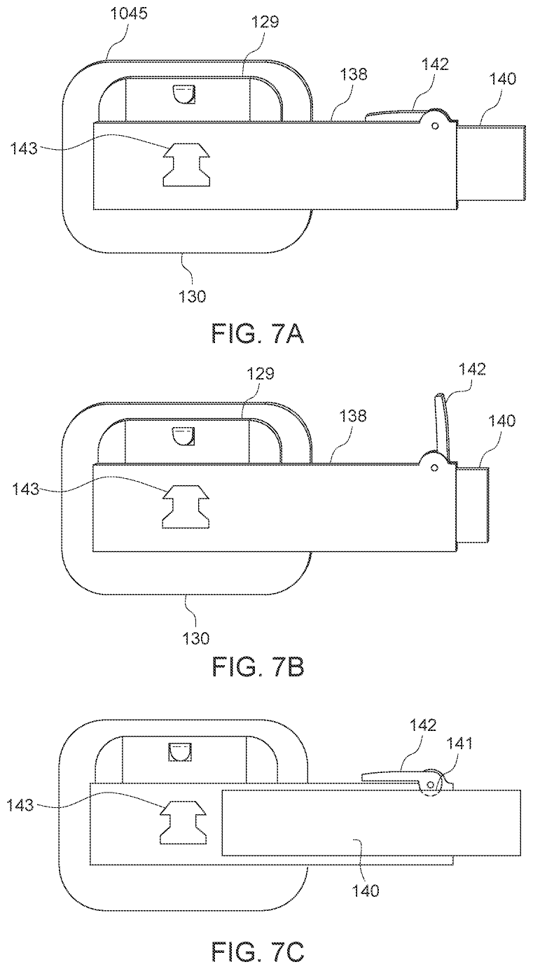

More particularly, the femoral portion end connector is movable about the thigh shaft 134, so as to adjust to accommodate lengths of various lengths amongst the patient pool. The femoral cam lever 136 is movable between a first position in which the femoral portion end connector 132 is movable about the thigh shaft 134, and a second, locking position in which the position of the femoral portion end connector 132 and thigh shaft 134 are fixed with respect to each other. In this exemplary embodiment, a cam lever is employed, though in alternative exemplary embodiments, a spring or like mechanism can be provided to bias the femoral cam lever 136 in the second, locking position. If a length change is desired, the femoral cam lever can be placed in the first position, for example, by manually pulling the lever (see FIGS. 7A-7C discussed below in connection with this exemplary embodiment) or alternatively, for example, by engaging the femoral cam lever 136 to overcome the spring bias.

The tibial portion 118 of the frame 102 is composed of a tibial portion end connector 138 and a tibial shaft 140. In this exemplary embodiment, the tibial portion end connector 138, like femoral portion end connector 132, is a female member which is dimensioned to receive tibial shaft 140. The position of the tibial portion end connector about the tibial shaft 140 can be adjusted by way of a tibial cam lever 142, which is identical to femoral cam lever 136. Other mechanisms known to the skilled artisan can be employed in its place. In this exemplary embodiment the tibial portion end connector 138 is composed of plastic, the tibial shaft is composed of a metal (e.g., stainless steel), though other materials can be provided instead for each.

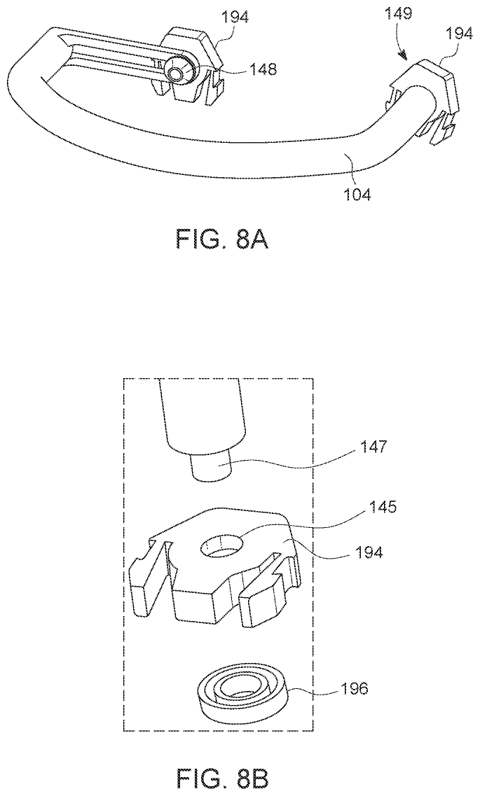

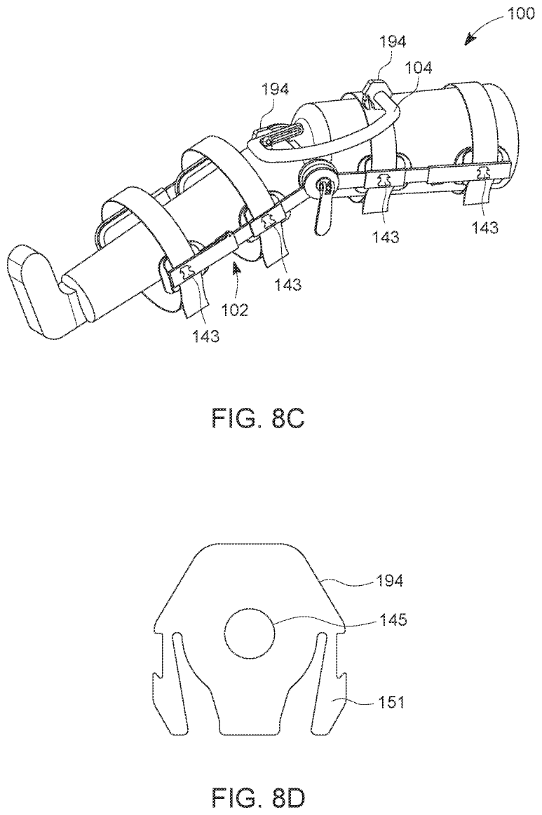

As shown in FIGS. 7A-7C, the outer surface of the tibial portion end connector 138 can optionally include a handle mating member 143 located adjacent the center of the lower calf pad 130. In this exemplary embodiment the handle mating member 143 is in the form of a recess specifically shaped and dimensioned to receive a male counterpart of similar shape (e.g., a snap clip of a similar shape). One or more identical mating member(s) can be located on an outer surface of: a housing 154 provided adjacent upper calf pad 128, the housing 146 provided adjacent lower thigh pad 126, and the femoral portion end connector 132, each mating member being capable of receiving a male counterpart mating member associated with the handle (FIGS. 3, 8C). For the surgical leg holder 100 discussed in this exemplary embodiment, handle mating members 143 are at least provided on the outer surface of the housing 154 provided adjacent upper calf pad 128, and the housing 146 provided adjacent lower thigh pad 126. Any suitable mating member or feature can be employed in the alternative in accordance with the disclosed subject matter.

The tibial portion end connector 138 engages with tibial shaft 140 in like manner as described above in connection with the engagement of the femoral portion end connector 124 and thigh shaft 134, with tibial cam lever 142 controlling the length of the tibial portion of the frame as best shown in FIGS. 7A-7C, discussed below.

In this exemplary embodiment, the exterior portion of the handle 104 extending from the frame has a u-shape, with a non-articulating end 150 mounted to the frame via the housing 146 provided adjacent the lower thigh pad 126 on the outer side of the frame 102, and an articulating end 152 in communication with a bolt 148 mounted on a housing 154 provide adjacent the upper calf pad 128, on the outer side of the frame. While other configurations, such as any of the handles disclosed in alternative embodiments of the subject disclosure, in this exemplary embodiment the handle 104 is a single unitary member that spans the joint 116 and thus bridges the femoral portion 120 and the tibial portion 118. The handle 104 can be secured to the frame 102 by any technique known to those of ordinary skill in the art, including, but not limited to, the particular, exemplary techniques discussed below in connection with alternative embodiments.

More particularly, the bolt 148 is sized to be slidable within a groove 156 that is provided about a flange 158 that defines the articulating end 152 of the handle. The flange 158 extends proximally along the outer side of the frame 102. The construction allows the handle 102 to accommodate movement from an outstretched position as shown in FIG. 1, to a retracted position as shown in FIG. 2, while maintaining communication with the frame 102 as the angle of the leg is positioned to a desired retraction position based on the particular surgical procedure being performed on the subject. Although not shown in this exemplary embodiment, an additional locking feature can optionally be added at the articulation point along articulating end 152 of the handle if additional rigidity is desired.

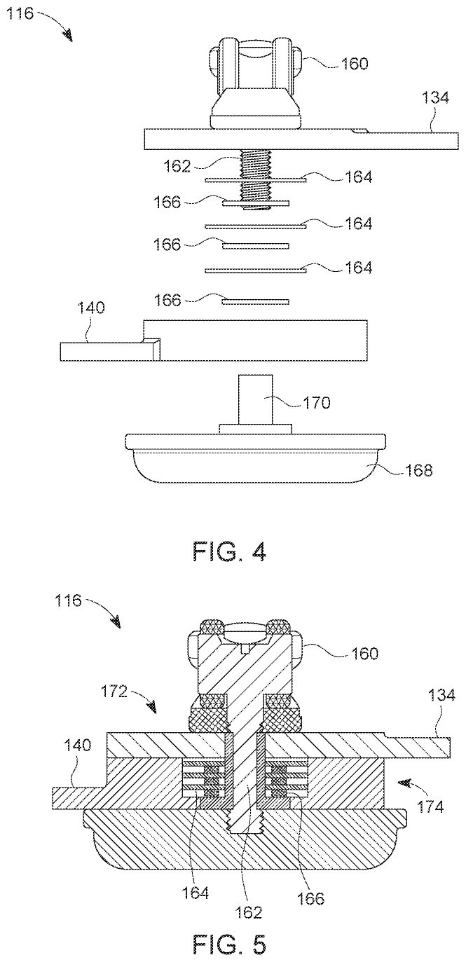

The joint 116 according to this exemplary embodiment is shown best in FIGS. 4 and 5. In this exemplary embodiment, the joint 116 includes a quarter-turn, cam-lock handle 160 and a threaded oblong-shaped shaft 162. The joint also includes a joint end piece 168 that includes a bore 170 extending from a center of the joint end piece. The bore 170 is shaped to receive the oblong-shaped shaft 162 that, by virtue of its shape and dimensioning, can be moved (i.e., quarter turned) between an unlocked position in which angular adjustment between the femoral portion 120 and the tibial portion 118 is possible and a locked position in which the angular position between the femoral portion 120 and the tibial portion 118 is locked.

A distal end 172 of the thigh shaft 134 is provided with an orifice, sized to receive the bore 170, which in turn is sized to receive the oblong-shaped shaft 162. A proximal end 174 of the tibial shaft is also provided with an orifice, sized to receive bore 170, as shown best in FIG. 5. A series of drag washers 164 and double-clipped washers 166, sequentially spaced, are provided about the bore 170 to provide friction and assist in easier manipulation of the device. The arrangement of the drag washers and double-clipped washers, though not limited to this particular placement, allows for a higher friction force in a compact profile by stacking multiple washers on top of each other.

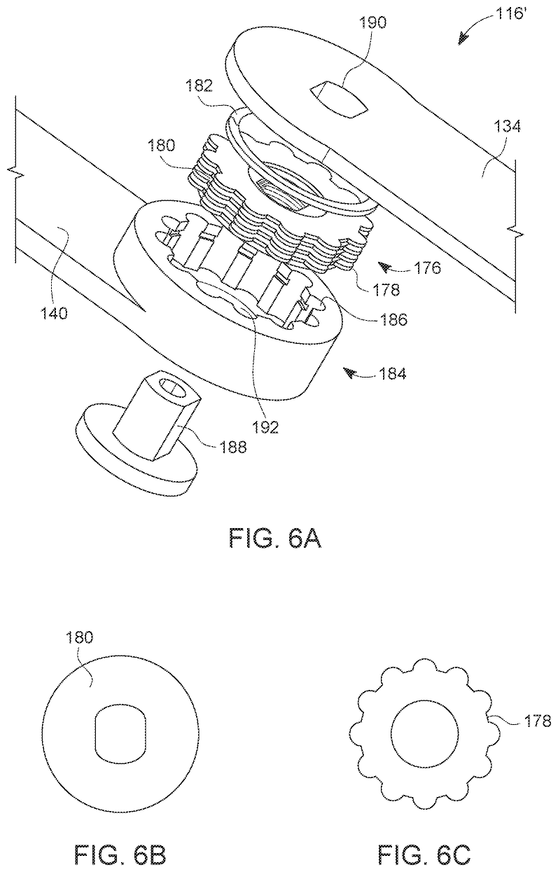

The construction of joint 116 is not limited to the construction described above, as any method to control the angular adjustment of the frame (e.g., adjustment of the angle between the tibial portion 118 and femoral portion 120 can be employed by the skilled artisan in accordance with the subject disclosure. For purposes of further illustration, and not limitation, the joint can instead be assembled like joint 116′, shown in FIGS. 6A-C, which employs clutch pack low-cost commercial/consumer off-the-shelf (COTS) items from fishing reel drag components.

More particularly, according to this alternative exemplary embodiment, a clutch pack 176 is provided, composed of fiber washers 178 and drag washers 180 stacked serially. The distal end of thigh shaft 134 is in communication with the clutch pack 176 via a retaining ring 182. A pin (not shown) that is sized and shaped to be received within an orifice 190 at the distal end of the thigh shaft 134. The proximal end of the tibial shaft 140 includes a torque hub 184 containing a recess 186 shaped and dimensioned to receive the components of the clutch pack 176, including the fiber washers 178. Adjustment of the stack size of the clutch pack can offer more or less friction as desired, with increasing the stack size providing more friction from the same clamping force.

A pin 188 is provided shaped and dimensioned to be inserted into an orifice 192 on the proximal end of the tibial shaft 140. The pin 188 is sized and shaped to be inserted to the orifice 192 and inside the drag washers 180. The joint 118′ according to this alternative embodiment, many of the components, such as torque hub 176 can be, for example, 3D printed or machined as desired.

A second frame 122, not having a handle or handle mating components in this exemplary embodiment, but otherwise having the same components as the frame 102, is provided facing the inner surface of frame 102. The second frame is spaced from the first frame to comfortably receive a standard size leg (based on the patient pool) and allow for the straps 106a-106d to tightly secure the leg for manipulation during the surgical procedure. In alternative embodiments, the frame 102 and second frame 122 are each individually equipped with one or more handle mating components, such as for embodiments in which the particular surgical procedure requires two professionals to hold and manipulate the leg on each side of the leg. Alternatively, as described below in connection with surgical leg holder 200, the handle can be mounted to or otherwise be in communication with both frame 102 and the second frame 122.

The structure of the cam lever 142, which is identical to cam lever 136, is shown best in FIGS. 7A-7C. FIGS. 7A and 7C (cross-section) disclose cam lever 142 in the second, locking position in which the position of the tibial portion end connector 138 and thigh shaft 140 are fixed with respect to each other. As shown best in FIG. 7C, in this position a projecting flange 141 engages the tibial shaft 140 via to forestall movement between the two members. In the first, unlocked position shown in FIG. 7B, the projecting flange 141 is moved out of contact with the tibial shaft to allow movement between the two members. Other structures can be provided in place of that shown here, which is provided for purposes of illustration and not limitation.

As noted above, the handle 104 can be secured to the frame 102 by any technique known to those of ordinary skill. FIGS. 8A-10 discloses exemplary techniques and structures. According to exemplary embodiments of the subject disclosure, the handle 104 can be provided as a single-use item separately from a re-usable (e.g., sterilizable) frame and/or fasteners. Still further, multiple handles of different types can be provided, so long as they are provided with complementary mating geometry or features as would be understood by persons of ordinary skill in the art. Indeed some or all of the instantly composed components can be provided sterilized and intended for a single use and then replaced, or provided as reusable components and sterilized after use as necessary (e.g., via use of an autoclave).

For example and with reference to FIGS. 8A-D, pivoting snap clips 194 that pivot independently can be provided and can be in for the form of a buckle or any other snap-fit type of geometry. Internal bearings 196 can be further provided to retain the handle 104 to the pivoting snap clips, while facilitating free rotation without binding. The snap clips include a centrally located, optionally threaded, orifice 145 sized to receive a post 147 that defines the proximal end 149 of the handle 104. The orifice 145 is also sized to receive the bolt 148.

To attach the handle 104 to the frame 102 according to this exemplary embodiment, the handle is secured to the snap clips 194 and the snap clips are inserted into the handle mating members 143. The handle mating members include flanges 151 that will create a clicking sound when securely engaged with the handle mating member 143. To remove the handle from the frame, one can manually depress the flanges 151 to disengage the snap clips 194 from the handle mating members 143. Similar or alternative techniques will present themselves to one of ordinary skill.

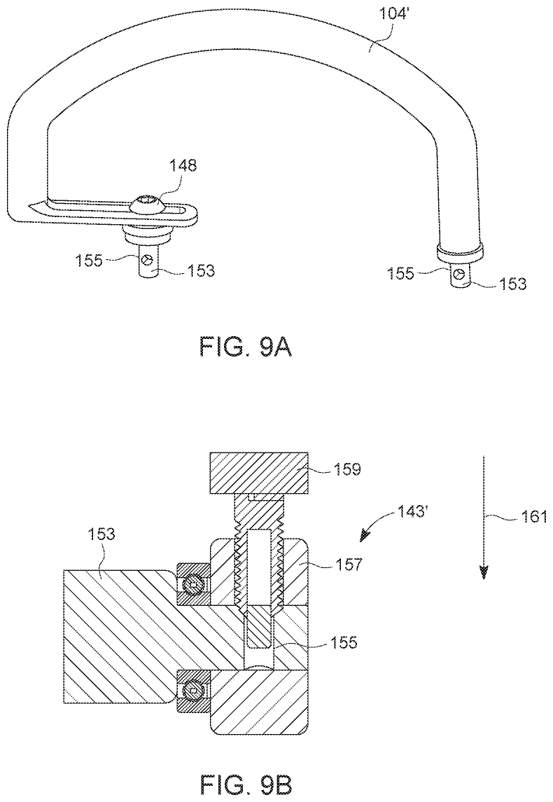

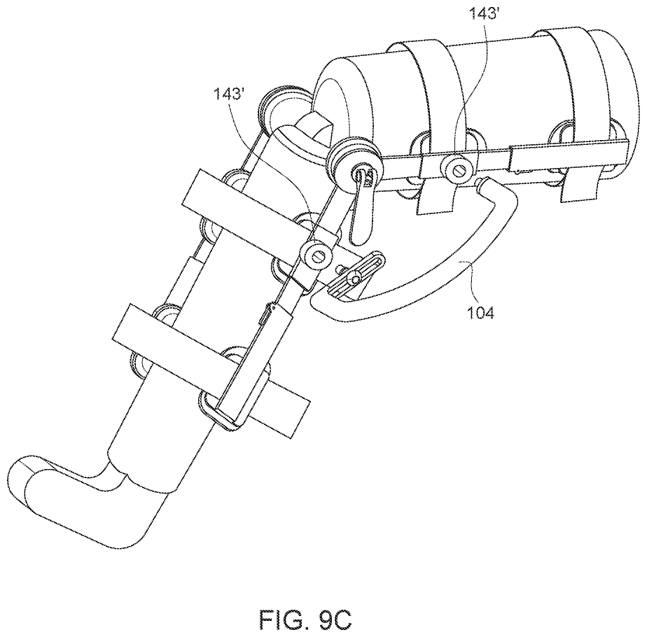

As another example, as shown in FIG. 9A-9C, a separate snap clip is not required. In this exemplary embodiment, each end of the handle 104′ is provided with a freely rotatable pin 153 with a center hole 155 for mating and alignment. The handle mating member 143′ is shown in FIGS. 9B and 9C and includes an orifice 157 sized to receive the rotatable pins 153. The mating member 143′ further includes a spring-loaded pin 159 that is biased in the direction of arrow 161 such that, when aligned with center hole 155, will engage the center hole to lock the handle into place, and a click is heard. When locked into place, the pins 153 remain capable of rotation. To disengage the handle, an operator can pull pin 159 against the bias of the spring to disengage the pin from orifice 155. Alternatively, different geometries (e.g., square or rectangular geometries) or components (e.g., a retaining clip) can be employed to better facilitate alignment.

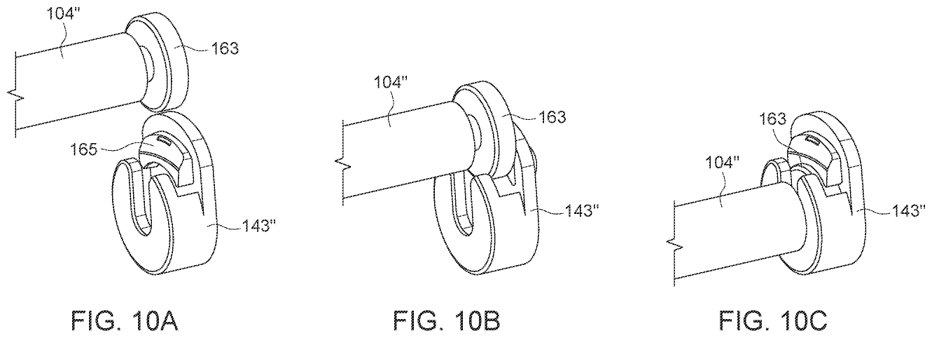

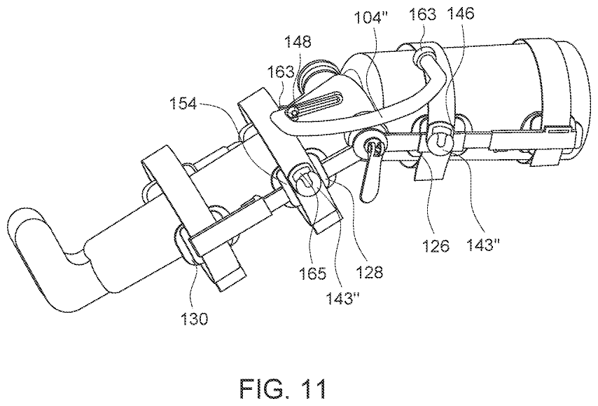

Still, further, the handle 104″ can be provided as shown in FIGS. 10A-11, in which the ends of the handle terminate with a planar plug 163 having, in this exemplary embodiment, a circular cross-sectional shape. The plug 163 can have other geometries, such as, but not limited to a flat rectangular shape or a shape with a wider base tapering towards the portion of the seat that is to be introduced to the mating member, as is commonly found in automobile seat belts. A plug 163 is also provided at the end of bolt 148.

The mating member 143″ according to this exemplary embodiment, includes a spring-loaded gate button 165 and a seat 167 shaped to receive and retain the plug against the gate button. As with mating members 143 and 143′, mating member 143″ can be mounted or otherwise disposed on the outer surface of the frame anywhere where a handle end could be desired, such as on an outer surface of: tibial portion end connector 130, the housing 154 provided adjacent upper calf pad 128, the housing 146 provided adjacent lower thigh pad 126, and the femoral portion end connector 132. As shown in FIG. 11, the mating member 144″ is provided along the outer surface of the housing 154 provided adjacent upper calf pad 128, and the housing 146 provided adjacent lower thigh pad 126, though other types of handles may suggest different configurations.

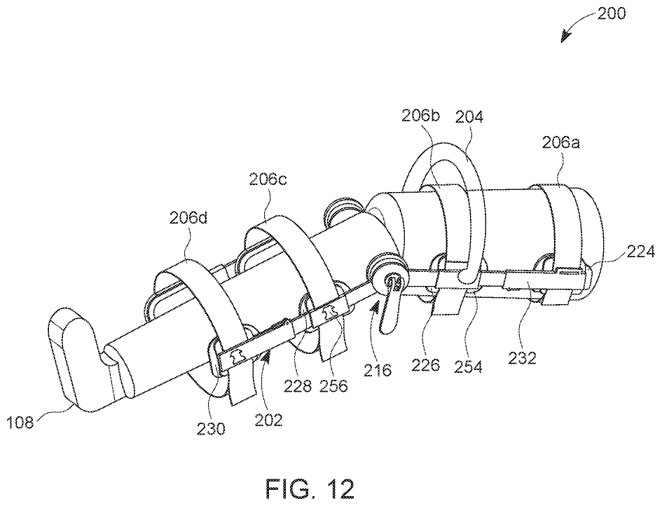

FIG. 12 illustrates a surgical leg holder 200 according to another exemplary embodiment of the subject disclosure. Surgical leg holder 200 is similar to surgical leg holder 100, and likewise includes a frame 202 that can be angularly adjusted, a handle 204 extending from the frame, a joint 216 and four fasteners in the exemplary form of four straps 206a-206d to circumscribe a portion of a leg 108. An upper thigh pad 224, a lower thigh pad 226, an upper calf pad 228, and a lower calf pad 230 are each mounted to or otherwise in attachment with the frame. The frame 202 also includes a femoral portion end connector 232, a housing 254 provided adjacent lower thigh pad 226, a housing 246 provided adjacent lower thigh pad 226, and a femoral portion end connector 232 is provided, similar to surgical leg holder 100. Housing 246 and housing 254 are provided with handle mating members (not shown).

A second frame 222 is provided, similar to second frame 122, and having the same components as frame 202, including handle mating member 243 provided along the outer surface of a housing provided adjacent the upper thigh pad of the second frame.

A distinguishing feature of surgical leg holder 200 is that the second frame 222 includes handle mating members, and the handle 204 is mounted to both the first frame 202 and the second frame 202. More particularly, the handle 204 is mounted to the lower thigh pads of the first and second frame. The U-shaped handle according to this exemplary embodiment is particularly suited for easy lifting of the entire leg.

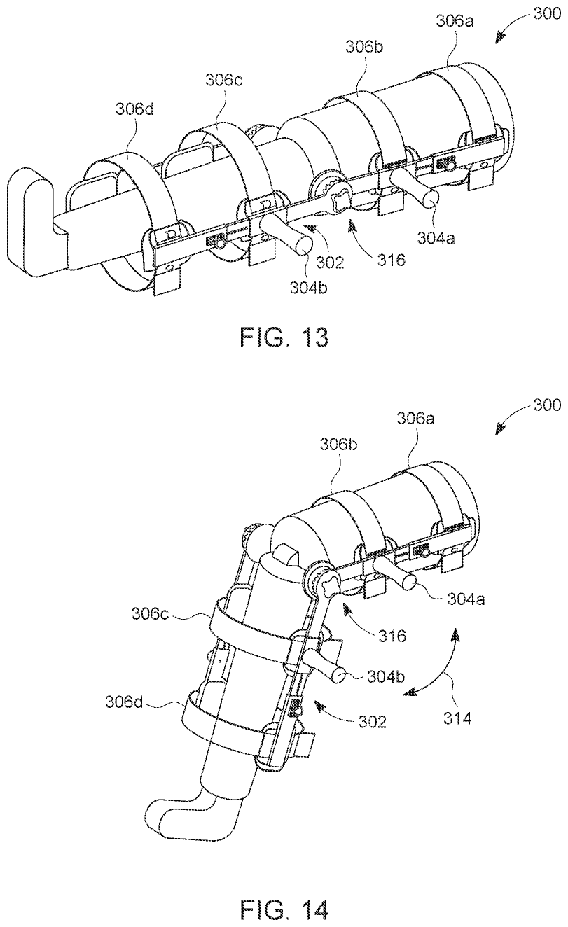

FIGS. 13 and 14 illustrate a surgical leg holder 300 according to yet another embodiment of the subject disclosure. The surgical leg holder includes a frame 302 that can be angularly adjusted, two handles 304a, 304b extending from the frame, and four fasteners in the exemplary form of four straps 306a-306d to circumscribe a portion of a leg 108. It is understood that all of the other frames, handles, or fasteners disclosed herein are generally interchangeable, and can be applied to surgical leg holder 300, or any of the other exemplary leg holders disclosed herein, though not mentioned specifically in connection therewith.

As noted, in this exemplary embodiment the fastener is in the form of four straps 306a-306d. In this exemplary embodiment, the straps are flexible and provided with hook and loop fasteners (e.g., Velcro®) and provided as generally described above in connection with straps 106a-106d. Alternatively, any other strap or similar mechanism can be used to secure the leg within the frames.

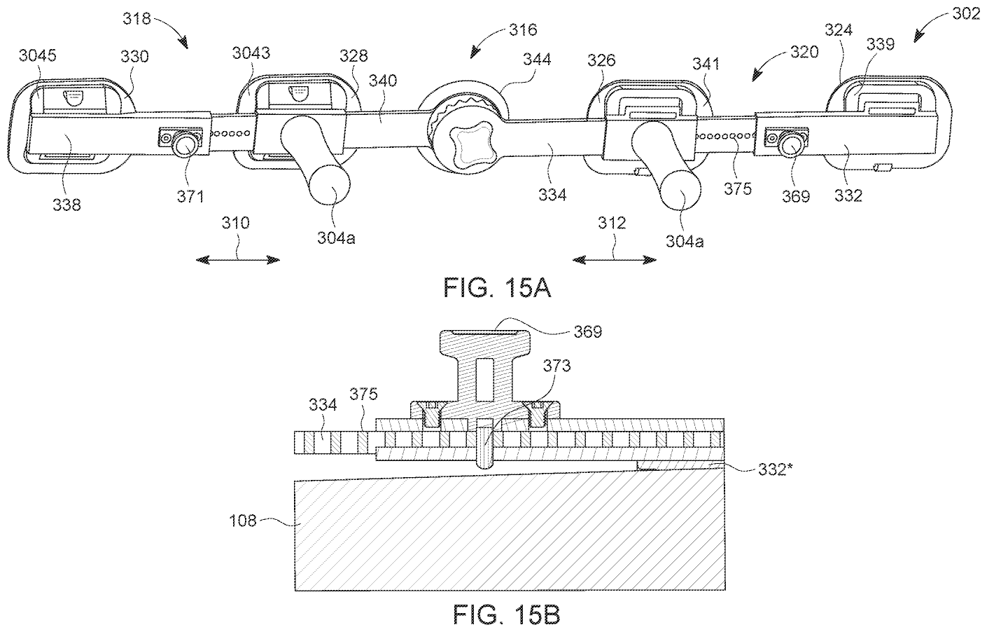

FIG. 15A depicts the frame 302 and handle 304 extending from the frame.

The frame 302 is capable of being moved in an axial direction, independently, along a length 310 of a lower portion of the device and adjacent the tibia and along a length 312 of an upper portion of the device and adjacent the femur, when used by a subject. The frame is also capable of angular adjustment 314 (e.g., between the position shown in FIG. 13 and the position shown in FIG. 14) about a joint 316 located between a tibial portion 318 and a femoral portion 320 of the frame 102, the joint 316 spaced to be in a position generally adjacent to the knee of a subject for which the device is being utilized.

In this exemplary embodiment, the femoral portion 320 of the frame 302 includes an upper thigh pad 324 mounted on the frame to define a proximal end of the femoral portion, and a lower thigh pad 326 of similar or like construction and size located proximal to the joint 316. The thigh pads 324, 326 are mounted to the frame via a relatively rigid backing 339, 341 which in turn can be mounted to the frame, frame housing or femoral portion end connector piece, or as shown here, formed integral with, respectively the housing and femoral end connector piece. A recess 323 is defined between the rigid backing 339 and upper thigh pad 324, and a recess 325 is defined between the rigid backing 341 and the lower thigh pad 326, each recess sized to receive the straps 306a and 306b, respectively to secure the fasteners to the femoral portion 320 of the frame 302. The tibial portion 318 includes an upper calf pad 328 and a lower calf pad 330 of similar or like constructions and size mounted thereon, the lower calf pad defining the distal end of the frame. As with the thigh pads, the calf pads 328, 330 are mounted to the frame via a relatively rigid backing 3043, 3045 which can similarly be mounted to the frame, frame housing or tibial end connector piece, or formed integral therewith. A recess 327 is defined between the rigid backing 3043 and upper calf pad 328 and a recess 329 is defined between the rigid backing 3045 and lower calf pad 330, each recess sized to receive the straps 106c and 106d, respectively to secure the fasteners to the tibial portion 318 of the frame.

A joint pad 344 is provided adjacent the joint 316, and is provided on the inner portion of the device that engages the leg, as are pads 324, 326, 328, 330. The pads can be comprised of foam or other like material to provide a soft and/or supporting surface for the leg, and can be mounted on the frame by way of a fastener, press fit, housing or other technique known to the skilled artisan.

The femoral portion of the frame 302 is composed of a femoral portion end connector 332 and a thigh shaft 334. In this exemplary embodiment, the femoral portion end connector is a female member which is dimensioned to receive a proximal end of the thigh shaft 334. The position of the femoral portion end connector about the thigh shaft 334 is adjusted by way of a femoral spring plunger 369 containing a pin 373 to mate with a series of orifices 375 provided along the proximal portion of the thigh shaft 334, as best shown in FIG. 15B. Other mechanisms known to the skilled artisan can be employed in its place. In this exemplary embodiment the femoral portion end connector 332 is composed of plastic, and the thigh shaft is composed of a metal (e.g., stainless steel), though other materials can be provided instead.

The femoral portion end connector 332 is movable about the thigh shaft 334, so as to adjust to accommodate lengths of various lengths amongst the patient pool.

The femoral spring plunger 369 is movable between a first position in which the femoral portion end connector 332 is movable about the thigh shaft 334, and a second, locking position in which the position of the femoral portion end connector 332 and thigh shaft 334 are fixed with respect to each other. If a length change is desired, the femoral spring plunger 371 can be placed in the first position, for example, by manually pulling the plunger to overcome the spring bias and remove the pin from occluding orifice.

The tibial portion 318 of the frame 302 is composed of a tibial portion end connector 338 and a tibial shaft 340. In this exemplary embodiment, the tibial portion end connector 338, like femoral portion end connector 332, is a female member which is dimensioned to receive tibial shaft 340. The position of the tibial portion end connector 338 about the tibial shaft 340 is adjusted by way of a tibial spring plunger 371, identical to the femoral spring plunger 369. Other mechanisms known to the skilled artisan can be employed in its place. In this exemplary embodiment the tibial portion end connector 338 is composed of plastic, the tibial shaft is composed of a metal (e.g., stainless steel), though other materials can be provided instead for each.

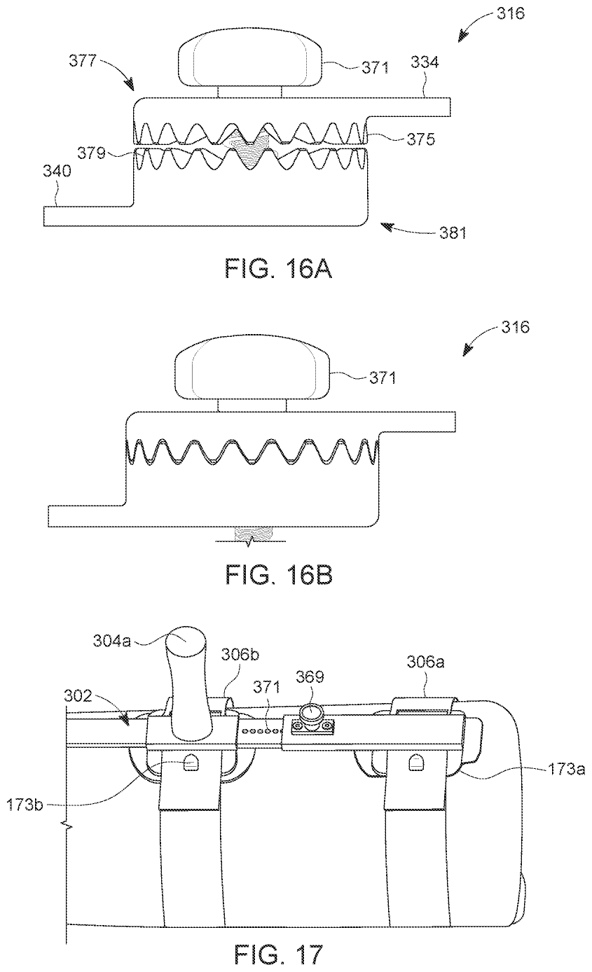

FIGS. 16A and 16B disclose the joint 316 according to this exemplary embodiment, which is in the form of a knob and serrated lock mechanism. The joint 316 includes a threaded dial 371 that is biased by a spring 373 toward a first, unlocked position shown in FIG. 16A. Threaded dial can be manually tightened against the bias of the spring to engage serrated teeth 375 present at a terminal hub 377 of the thigh shaft 334, and complementary serrated teeth 379 present a terminal hub 381 of the tibial shaft 340 to achieve a second, locked position shown in FIG. 16B. Loosening the threaded dial 371 will disengage the serrated teeth of the terminal hubs to return the joint to the first, unlocked position in which angular adjustment between the thigh shaft 334 and tibial shaft 340 can be achieved. As would be appreciated by one of ordinary skill in the art, A cam lock, quarter-turn handle, or other like mechanism could be employed instead in accordance with the disclosed subject matter.

FIG. 17 depicts a detailed view of the proximal end of the surgical device. In this exemplary embodiment the straps 306a and 306b are flexible and function akin to straps on a belt for a backpack. Standard buckles 173a and 173b are provided on each strap, shown schematically in FIG. 17. A person of ordinary skill will envision possible variations that can be practiced in accordance with this embodiment, and the disclosed subject matter generally.

The handles 304 can be mounted to the frame by any technique known to those of ordinary skill, including, for example, as disclosed in connection with FIGS. 8A-11 discussed above.

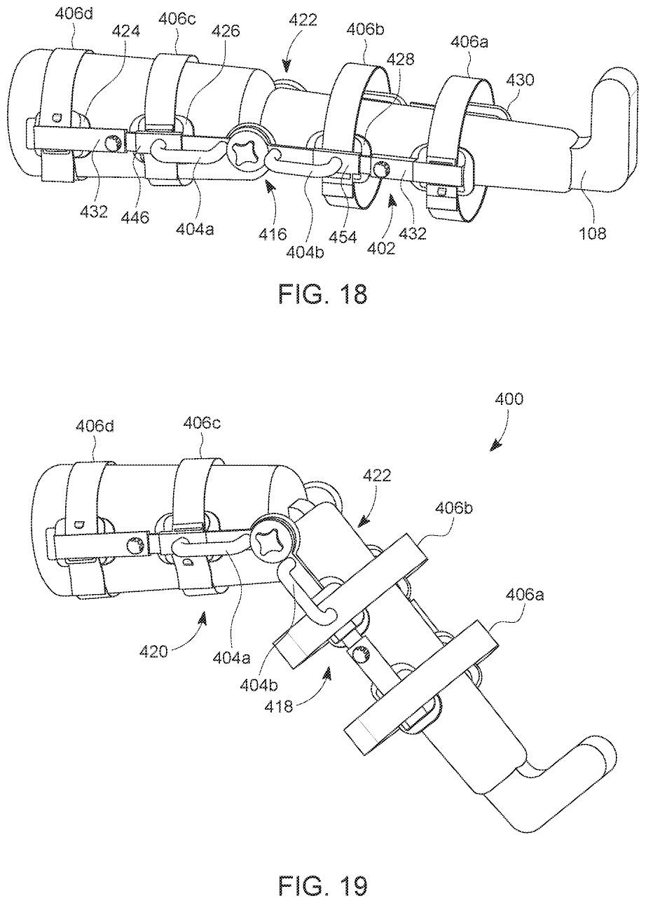

FIGS. 18 and 19 illustrate a surgical leg holder 400 according to yet another exemplary embodiment of the subject disclosure. Surgical leg holder 400 is generally similar to surgical leg holder 300, and likewise includes a frame 402 that can be angularly adjusted that includes a joint 416, and four fasteners in the exemplary form of four straps 406a-406d are provided to circumscribe a portion of a leg 108. This exemplary embodiment, however, includes two u-shaped handles 404a, 404b extending from the frame 402.

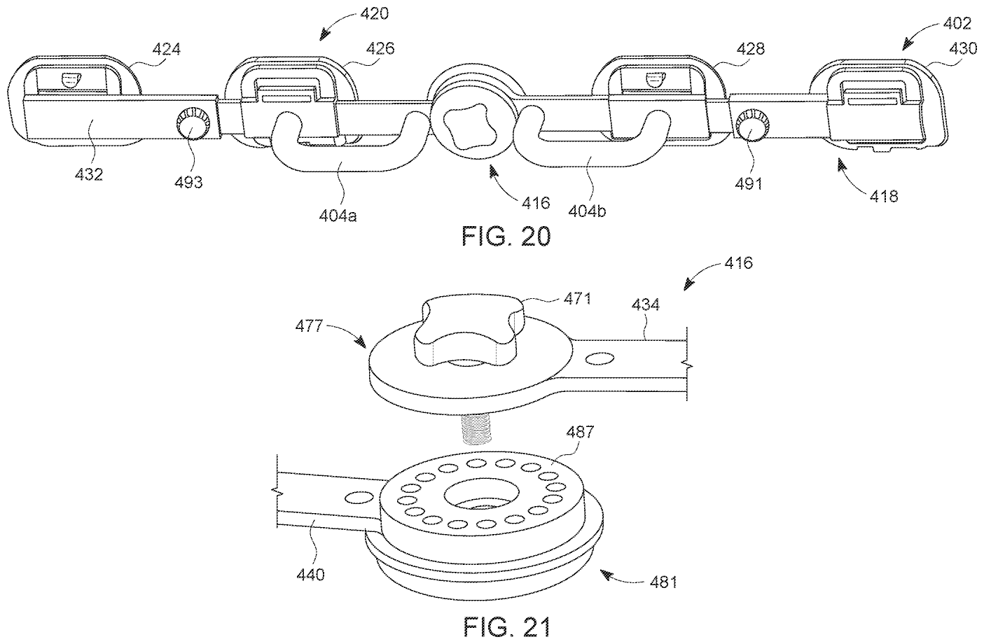

As shown best in FIG. 20, the frame 402 similarly includes an upper thigh pad 424, a lower thigh pad 426, an upper calf pad 428, and a lower calf pad 430 mounted to or otherwise attached to the frame. In addition, the frame includes a femoral portion end connector 432, a housing 454 provided adjacent upper calf pad 428, a housing 446 provided adjacent lower thigh pad 426, and a femoral portion end connector 432, similar to surgical leg holder 300 as described above. As with the other surgical leg holders disclosed herein, the portion of the frame proximal to joint 416 defines a femoral portion 420 of the frame, and the portion of the frame distal to the joint defines a tibial portion 418 of the frame.

Housing 446 and housing 454 are provided with handle mating members 243. As noted with respect to prior embodiments, the housings 446, 454 and relatively rigid backings, discussed below, can be formed integral or as separate components. A second frame 422 is provided, similar to second frame 322, and having the same components as frame 402.

A distinguishing feature of surgical leg holder 400 are the two U-shaped handles, one handle 404a extending from the femoral portion 420 of the frame and one handle 404b extending from the tibial portion 118 of the frame. Among other advantages, this configuration allows for a user of the device to isolate manipulating force on an upper or lower extremity of the leg, and also facilitates easier handling by two professionals, if required or convenient, during the surgical procedure.

Surgical holder 400 is also distinguished by the particular joint 416 employed, as well as the particular mechanism to independently control the length of the femoral portion 420 and the tibial portion 418. While discussed below in connection with surgical leg holder 400, these particular joints and mechanisms can also be applied to the other surgical leg holders disclosed herein (e.g., surgical leg holders 100, 200, 300).

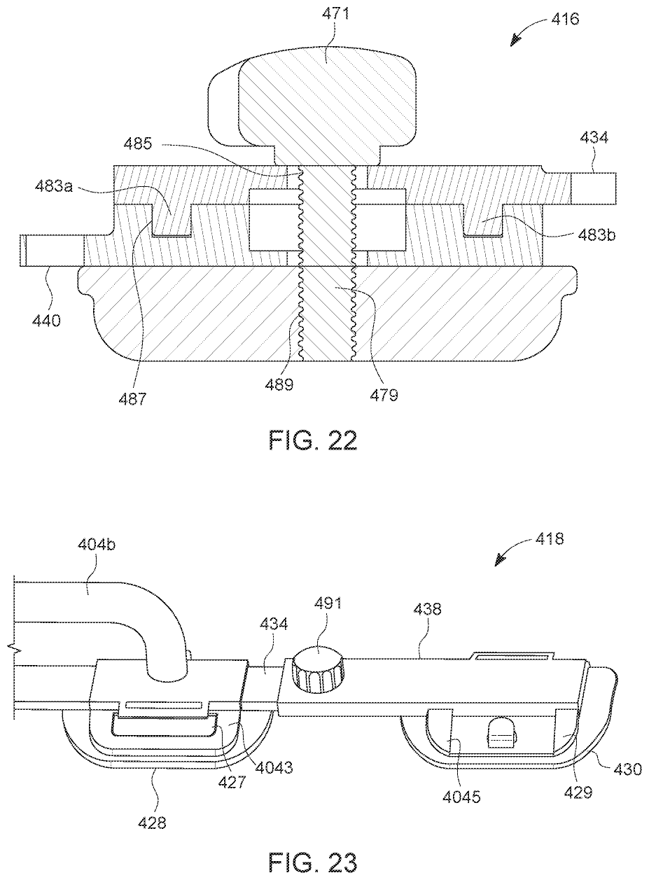

Joint 416 is shown in FIGS. 21 and 22 and is similar to joint 316 in that a terminal hub 477 defines the distal end of the thigh shaft 434 and a complementary terminal hub 481 defines a proximal end of the tibial shaft 440, the terminal hubs capable of being rotated with respect to each other in a first, unlocked position (FIG. 21), and locked (i.e., unable to be rotated with respect to each other) in a second position (FIG. 22). Also, similar to joint 316, tension is applied to a terminal hub to engage the two hubs by a threaded dial 471 which can be manually tightened to engage the hugs to place the joint in the locked, second position and loosened to disengage the hubs and place the joint in the first, unlocked position.

In this exemplary embodiment, the thigh shaft terminal hub 477 includes two pins 483a, 483b spaced radially from a centrally located orifice 485 provided in the center of terminal hub 477. The orifice 485 is threaded complementary to, and sized to receive a shaft 479 of the threaded dial 471. The pins 483a, 483b are spaced across from each other with respect to the radial center of the terminal hub and threaded orifice 485, as shown in FIG. 22, though multiple pins (e.g., 3 or 4) can be instead provided and equally spaced radially about the hub.

The tibial shaft terminal hub 481 includes a series of outer orifices 487 equally spaced radially about an orifice 489 that is provided about the center of the terminal hub. Orifice 489 is also threaded and sized to receive the shaft 479 of the threaded dial. From a first, unlocked position shown in FIG. 21, the pins 483a, 483b are manually aligned with the appropriate outer orifice 487, and the threaded dial is tightened to place the dial in the locked position shown in FIG. 22.

FIG. 23 discloses a detailed view of the tibial portion 418 of the frame 402, and the engagement of the tibial end portion connector 438 with the tibial shaft 434. As in the surgical devices disclosed above, the tibial portion end connector is a female member which is dimensioned to receive a distal end of the tibial shaft 434. The length of the tibial portion of the frame is achieved via a quarter turn dial 491 containing a shaft capable of engaging and disengaging the tibial shaft 434. The quarter turn dial 491 can be loosened by a quarter-turn (e.g., counterclockwise) to disengage the shaft and tightened by a quarter-turn in the opposite direction. Though not provided in this exemplary embodiment, the tibial shaft can be provided with fixed increment orifices or slots, grooves, or other techniques known to those of ordinary skill in the art. Adjustment of the femoral portion of the frame 420 is achieved via quarter turn dial 493 identical to quarter turn dial 491.

FIG. 23 also details the mounting of the lower calf pad 430 and the upper calf pad 428. As discussed above, the calf pads 428, 430 are mounted to the frame via a relatively rigid backing 4043, 4045, respectively, which can similarly be mounted to the frame, frame housing or tibial end connector piece or formed integral therewith. A recess 427 is defined between the rigid backing 1043 and upper calf pad 128 and a recess 429 is defined between the rigid backing 4045 and lower calf pad 430, each recess sized to receive the straps 106c and 106d, respectively to secure the fasteners to the tibial portion 118 of the frame. Alternatively, for example, the lower calf pad 430 can be formed integral with the tibial portion end connector 438, and similarly, the upper thigh pad 424 can be formed integral with the femoral portion end connector 432.

The handles 404a, 404b can be mounted to the frame by any technique known to those of ordinary skill, including, for example, as disclosed in connection with FIGS. 8A-11 discussed above. As shown in FIG. 18, the distal end of handle 404a and the proximal end of handle 404b can be mated directly to the frame with a screw, rivet or like fastener, or any other means known to those of skill in the art to provide a rigid connection.

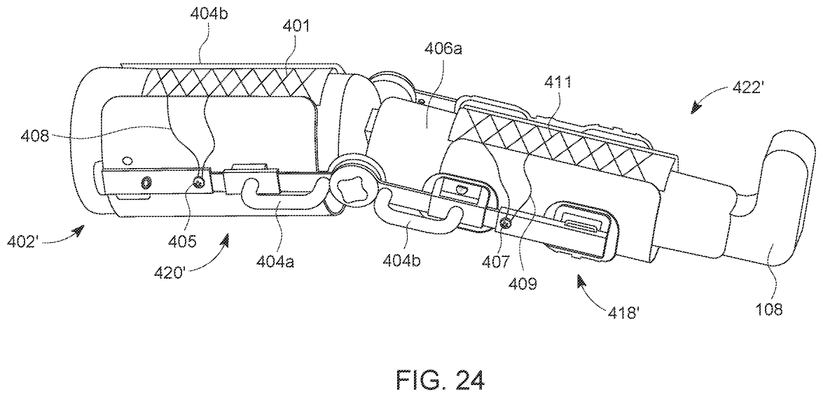

The fasteners disclosed in the above exemplary embodiments, including straps 406a-d in surgical leg device 400, can be, for example, flexible straps provided with hook and loop type fasteners (e.g., Velcro®) or similar to backpack straps on a backpack and provided with a buckle or other mechanism. This form of fastener is not limiting, as FIGS. 24-28C disclose alternative forms of fasteners in the context of surgical device 400, though these fasteners are generally interchangeable and can also be applied to any of the other surgical leg devices disclosed herein (e.g., surgical devices 100, 200, 300).

With reference to FIG. 24, surgical device 400′ is shown, and is identical to surgical device 400 except that a pair of interlaced sleeves 406a′, 406b′ are provided, respectively, about the lower leg/calve area and upper leg/thigh area of the leg 108. The interlaced sleeves are of a type known in the art in which an external loop 495 of the inter-laced thin wires or laces 497 can be attached to a twist-lock dial 499 or other mechanism (e.g., a ratcheting mechanism) to apply or remove tension to the wires or laces and in turn, tighten and loosen the wires laces as needed to accommodate and secure a variety of leg sizes. In this exemplary embodiment, unlike surgical device 400, do not employ variable length adjustment.

More particularly, interlaced sleeve 406b includes inter-laced thin wires or laces 401 having an external loop 403 extended from the interior of the sleeve. A femoral portion 420′ of the frame 402′ includes a twist lock dial 405 proximal to handle 404a that is positioned to receive the external loop 403 and apply tension to the wires or laces 401 by rotating the twist-lock dial 405 (e.g., clockwise) and capable of being engaged to release the tension (e.g., by pushing or pulling the twist-lock dial).

The circumference of interlaced sleeve 406a is adjusted by the same mechanism. A tibial portion 418′ of the frame 402′ includes a second twist lock dial 407 that is similarly positioned to receive an external loop 409 of wires or laces 411 interlaced throughout the interior of the sleeve. The external loops 403, 409 engagement with twist-lock dials 405, 407 secures the sleeve to the frame 402. The sleeve can be further secured to the frame with pockets (e.g., sewn into the sleeve) or with snap fasteners or rivets.

The twist-lock dials 405, 407 is this exemplary embodiment is a BOA® dial, from Boa Technology, which is currently commercially exploited in connection with hiking boots, snowboard boots, ski boots, and other heavy boots and binders, cycling, running and athletic shoes, and medical bracing (e.g., ankle braces, back brace, knee brace, etc.). See https://www.boafit.com/en-us/. Alternatively other types of ratcheting-type mechanisms (e.g., ratcheting-type dial or rotary mechanisms) can be employed to apply and remove tension to wires or laces that are interlaced within the sleeve, such as wires or laces based similar products commercially available from Sidi and Shimano.

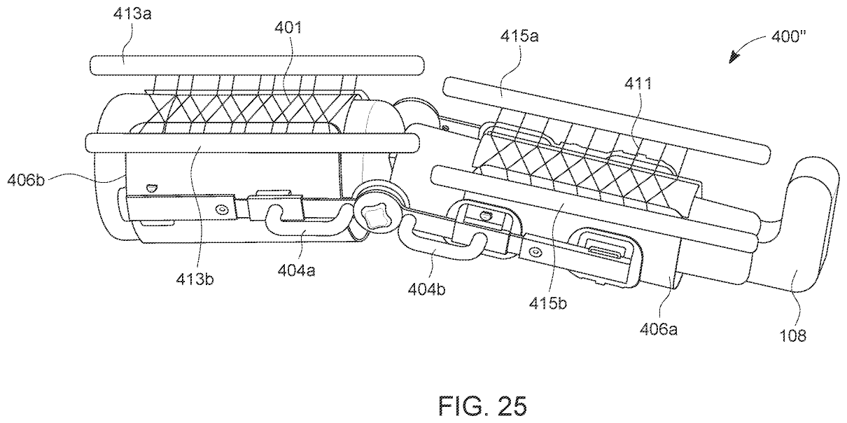

FIG. 25 discloses a surgical leg holder 400″ according to an alternative exemplary embodiment that is similarly provided with sleeves 406a, 406b interlaced with thin wires or laces 401, 411. In this exemplary embodiment, laces 401 terminate at a pair of pull tabs 413a, 413b capable of being manually manipulated and laces 411 terminate at a pair of pull tabs 415a, 415b, identical to pull tabs 413. The outer surface of the pull tabs are provided with a hook and loop type fastener (e.g., Velcro®) to secure the tabs. As with surgical leg holder 400′, the sleeve can be secured to the frame with pockets (e.g., sewn into the sleeve) or with snap fasteners or rivets.

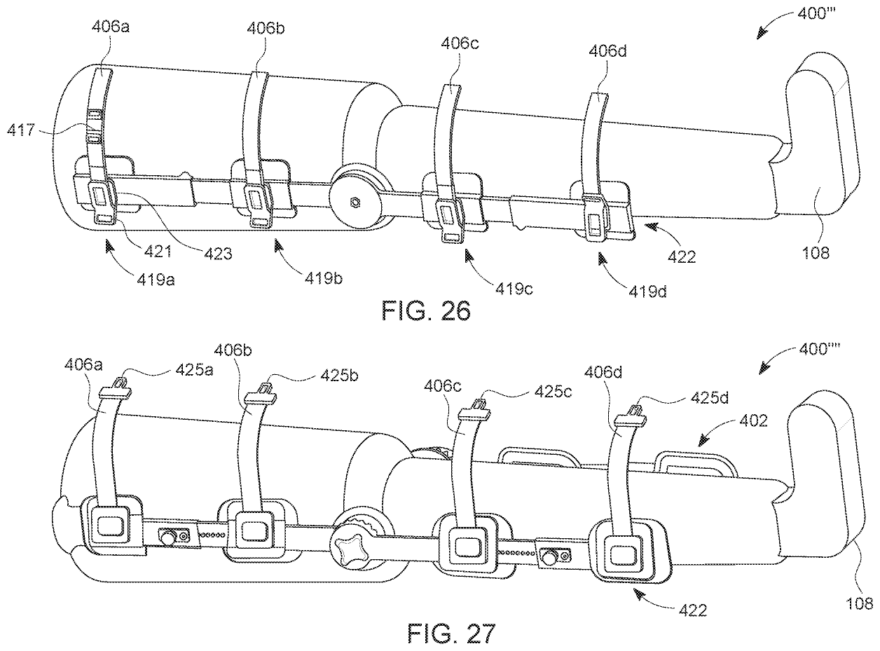

FIG. 26 discloses a surgical leg holder 400″ according to an alternative exemplary embodiment that is similar to surgical leg holder 400, but instead of flexible straps 406a-d, provided with hook and loop type fastener (e.g., Velcro®), the fasteners 406a-d′ are in the form of plastic bindings containing incrementally-spaced grooves 417 adapted to be received by a series of ratcheting levers 419a-d disposed adjacent the thigh and knee pads that are mounted to second frame 422. The plastic bindings can include along leg-facing surfaces, for example, a rubber inlay or other ergonomic feature to increase comfort. The ratcheting levers 419a-d each including a pumping lever 421 to tighten the straps and a release lever 423 to release the tension.

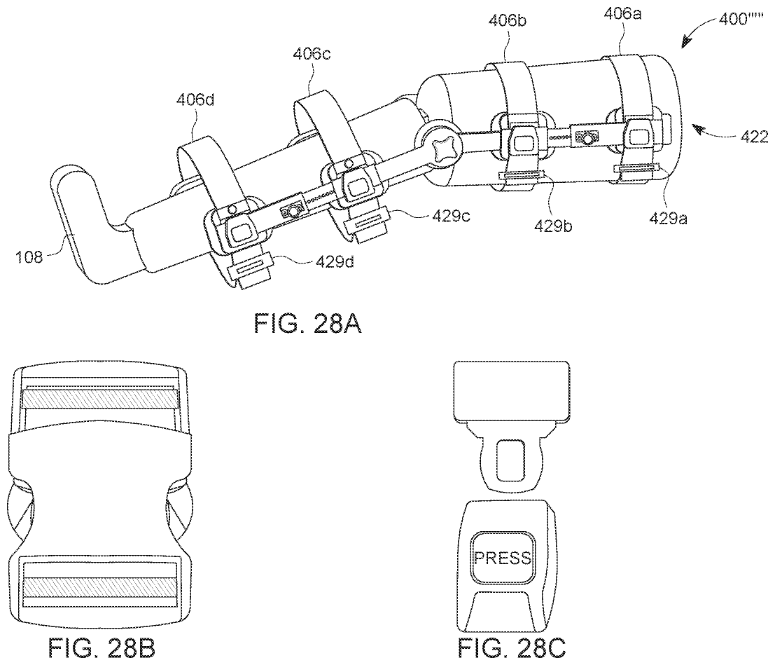

FIG. 27 discloses a surgical leg holder 400″″ according to an alternative exemplary embodiment that is similar to surgical leg holder 400, but the fasteners 406a-d are in the form of an elastic strap having a male terminal ends 425a-d. The straps 406a-d are looped through frame 402 and underneath the leg 108. The male terminal ends 425a-d are introduced to a female belt component or buckle 427a-d located adjacent thigh and calf pads along the second frame 422. The straps a sufficient elasticity to tightly accommodate a variety of leg sizes, as shown in FIG. 27. Alternatively, as shown in FIG. 28A and surgical leg holder 400′″″, the fasteners can be in the form of a belts 406a-d of the type commonly found in automobiles, in which case a series of clamps 429a-d can be provided to accommodate excess belt length. The buckles 427a-d can take a variety of forms, such as disclosed in FIGS. 28B and 28C.

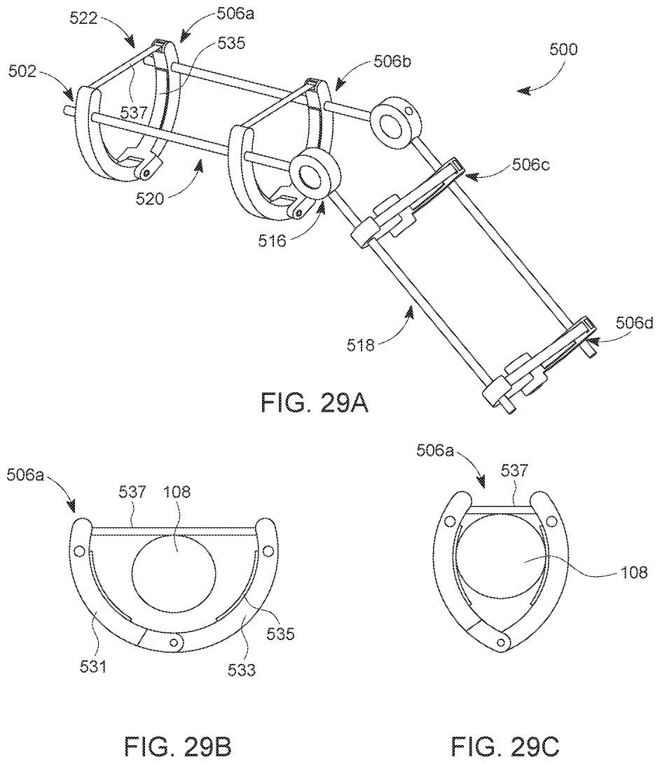

FIG. 29A discloses an alternative fastener in the context of surgical leg device 500 and an alternative embodiment of the subject disclosure. The surgical leg device includes a frame 502 in the form of a round strut and capable of angular adjustment about a joint 516 located between a tibial portion 518 and a femoral portion 520 of the frame 502, the joint 516 spaced to be in a position generally adjacent to the knee of a subject for which the device is being utilized. A second frame 522 having the same components is provided adjacent the first frame 502, the two frames receiving a series of fasteners 506a-d.

The fasteners 506a-d in this exemplary embodiment are each in the form of two plastic c-clamps 531,533 interlocked at ends. As shown in FIGS. 29B and 29C, the c-clamps can be opened to form a u-shaped cross-sectional shape and closed to form more of a v-shaped cross sectional shape and secure leg 108 within the frames 502, 522. Each c-clamp includes a rubber inlay 535 or other ergonomic feature along leg-facing surfaces. The fasteners 506a-d further include a belt or strap 537 linking the non-joined ends of the c-clamps 531, 533 and securing the leg.

The surgical leg holder according to the subject disclosure can be used during any surgery in which it is desired to manipulate the leg, such as any procedure requiring distraction of the leg to achieve joint and/or limb dislocation, reduction, compression, or positioning.

Operation of the surgical leg holder of the subject disclosure is described here in connection with an anterior hip replacement procedure, though use of the presently disclosed surgical leg holder is not limited thereto. While draping the extremities with sterile attributes on the surgical field, the surgical team can apply the instant surgical leg holder on the operative side over the patient's thigh and calf area. Once a desired leg flexion angle is obtained, the straps and sleeve are used to secure the device to the leg. During surgery, the surgeon or assistant can release the lock to place leg in extension.

When the surgeon is ready for femoral preparation, an assistant can place the handle to the leg holder closer to the medial side in order to provide leverage for the assistant to achieve rotation of the leg, providing optimal exposure. An operating room professional secures the handle with their hand, and moves the operative leg to the adduction position, and rotates the handle toward the lateral position to provide the same leg position while providing increased stability of the operative site. As will be readily apparent, this provides the operating room professional mechanical leverage that reduces the risk of losing leg position and stability due to fatigue while surgeon prepares the femoral canal with exposure, reaming, broaching and prosthesis placement.

During trial reduction the surgical team members will hold the handle as leverage to pull and rotate the leg when inserting the hip joint back in place. The surgeon will then evaluate the stability of the joint. Once complete, the assistant must dislocate the hip joint to remove all trial components. This is done by the assistant using the handle as leverage to pull and rotate the leg in order to dislocate the hip joint and remove the trial component. The same steps may be used for implantation of the final components to reduce the hip joint back into place. Components can then be examined, and the surgical team members can remove the surgical leg holder from the patient's leg.

It will be appreciated by those skilled in the art that changes could be made to the exemplary embodiments described above without departing from the broad inventive concept thereof. It is to be understood, therefore, that this disclosure is not limited to the particular embodiments disclosed, but it is intended to cover modifications within the spirit and scope of the subject disclosure as described above.

1. A surgical leg holder for manipulating a leg during surgery, the surgical leg holder comprising:
a frame comprising a proximal femoral portion, a joint and a tibial portion distal the joint, the frame capable of angular adjustment about the joint;
one or more handles extending from the frame; and
one or more fasteners to circumscribe at least a portion of a leg to secure the leg to the frame.

2. The surgical leg holder of claim 1, wherein at least one handle extends from both the femoral portion and the tibial portion of the frame.

3. The surgical leg holder of claim 2, wherein the at least one handle is a single, u-shaped handle with one end extending from the femoral portion of the frame and one end extending from the tibial portion of the frame.

4. The surgical leg holder of claim 2, wherein the at least one handle comprises a first handle extending from the femoral portion of the frame and a second handle extending from the tibial portion of the frame.

5. The surgical leg holder of claim 1, further comprising one or more pads secured to an inner side of the frame.

6. The surgical leg holder of claim 5, comprising at least one pad secured to the femoral portion of the frame and at least one pad secured to tibial portion of the frame.

7. The surgical leg holder of claim 1, wherein the femoral portion of the frame includes a femoral portion end connector and a thigh shaft, the femoral portion end connector capable of being placed in a first position in which the femoral portion end connector is movable about thigh shaft about an axial direction and a second position in which the femoral portion is locked with respect to the thigh shaft.

8. The surgical leg holder of claim 7, wherein the tibial portion of the frame includes a tibial portion end connector movable about a tibial shaft, the tibial portion end connector capable of being placed in a first position in which the tibial portion end connector is movable about the tibial shaft about an axial direction and a second position in which the tibial portion is locked with respect to the tibial shaft.

9. The surgical leg holder of claim 1, wherein a distal end of the femoral portion of the frame is defined by a hub and a proximal end of the tibial portion of the frame is defined by a second hub.

10. The surgical leg holder of claim 9, wherein the joint is capable of being placed in a first position in which the first hub is rotatable about the second hub and a second position in which the first hub and second hub cannot be rotated with respect to each other.

11. The surgical leg holder of claim 1, wherein the one or more fasteners includes one or more of a belt, strap, sleeve or clamp.

12. The surgical leg holder of claim 1, further comprising a second frame, the one or more fasteners securing the leg between the first frame and the second frame.

13. The surgical leg holder of claim 12, wherein a single handle extends from the first frame and the second frame.

14. The surgical leg holder of claim 1, wherein an outer surface of the frame comprises one or more handle mating members.

15. A method of manipulating a leg during a surgical procedure comprising introducing the leg to a surgical leg holder, the surgical leg holder comprising:
a frame comprising a proximal femoral portion, a joint and a tibial portion distal the joint, the frame capable of angular adjustment about the joint;
one or more handles extending from the frame; and
one or more fasteners to circumscribe at least a portion of a leg to secure the leg to the frame.

16. The method of claim 15, wherein at least one handle extends from both the femoral portion and the tibial portion of the frame.

17. The method of claim 15, wherein the at least one handle is a single, u-shaped handle with one end extending from the femoral portion of the frame and one end extending from the tibial portion of the frame.

18. The method of claim 15, The surgical leg holder of claim 2, wherein the at least one handle comprises a first handle extending from the femoral portion of the frame and a second handle extending from the tibial portion of the frame.

19. The method of claim 15, wherein a distal end of the femoral portion of the frame is defined by a hub and a proximal end of the tibial portion of the frame is defined by a second hub.

20. The method of claim 15, wherein the joint is capable of being placed in a first position in which the first hub is rotatable about the second hub and a second position in which the first hub and second hub cannot be rotated with respect to each other.
